(19) United States
(12) Patent Application Publication
(10) Pub. No.: US 2009/0046365 A1
(43) Pub. Date: Feb. 19, 2009

(54) REMOVABLE COVER

(76) Inventor: Larry E. Moore, Cottonwood, AZ (US)

Correspondence Address: SQUIRE SANDERS & DEMPSEY LLP, TWO RENAISSANCE SQUARE, 40 NORTH CENTRAL AVENUE, SUITE 2700, PHOENIX, AZ, 85004-4498, US

(21) Appl. No.: 11/840,166

(22) Filed: Aug. 16, 2007

(51) Int. Cl. G02B 23/18

(52) U.S. Cl. 359/511

(57) ABSTRACT

A cover for an optical instrument or device includes a preferably flexible hood for partially covering and alternately uncovering the optical instrument and a connector attached to the hood for securing the hood to the optical instrument while the instrument or device is uncovered.

### FIELD OF THE INVENTION

The present invention relates generally to removable covers, and more particularly to a removable cover for an optical instrument or electronic device.

### BACKGROUND OF THE INVENTION

Cameras, telescopes, binoculars, and other optical instruments are used in a wide variety of applications. Such devices are often expensive, yet are susceptible to damage and/or impairment from dust, moisture, the shock of a fall, collision with another object, and other hazards. In particular, optical instruments generally have one or more lenses that are particularly vulnerable to scratching, chipping, or other forms of permanent damage that can degrade or eliminate the usefulness of the instrument. Additionally, optical instruments may include delicate electronic components that are equally susceptible to damage.

Similarly, many portable electronic devices, such as cellular phones, personal digital assistants (PDAs), and media players are susceptible to many of the same hazards as optical instruments, particularly ones with a display screen. Many electronic devices contain components that can be destroyed or damaged by the exposure to moisture, extreme temperatures, or dust, and have display screens that can be scratched or marred if not protected. In some cases, optical instruments and electronic devices are integrated together, such as the case with cellular phones containing digital cameras. In addition, the cosmetic exterior of an electronic and/or optical device can be marred if not protected, reducing the visual appeal (and often the value) of the device. These and other issues are addressed by the present invention.

### SUMMARY OF THE INVENTION

One exemplary embodiment of the present invention is a cover for an optical instrument. The cover includes a (preferably flexible) hood for partially covering and alternately uncovering the optical instrument and a connector attached to the hood for securing the hood to the optical instrument while the instrument is uncovered. This exemplary embodiment of the present invention may be configured to fit any type of optical instrument, but is most preferably configured for a binocular.

Another exemplary embodiment of the present invention is a cover for a device, such as an optical instrument or electronic device. The cover includes a flexible hood with a closed top, four sides, and a substantially open bottom. A cavity defined by the top and four sidewalls receives the device and a connector attached to the cover (most preferably to the interior of one of the sides) secures the hood to the device. This exemplary embodiment of the present invention may be configured to any type of optical or electronic device.

### BRIEF DESCRIPTION OF THE DRAWINGS

FIG. 1 is a top view of a cover according to an exemplary embodiment of the present invention.

FIG. 2 is a bottom view of the cover depicted in FIG. 1.

FIG. 3 is a side view of the cover depicted in FIG. 1.

FIG. 4 depicts a pattern from which the cover depicted in FIG. 1 can be fabricated.

FIG. 5 is a top view of a cover according to another exemplary embodiment of the present invention.

FIG. 6 is a bottom view of the cover depicted in FIG. 5.

FIG. 7 shows the cover depicted in FIG. 5 covering an optical device.

FIG. 8 depicts top and bottom views of an exemplary cover formed from a camouflaged material.

FIG. 9 depicts a pattern from which the cover depicted in FIG. 5 can be fabricated.

FIG. 10 illustrates how the pattern depicted in FIG. 9 can be assembled to form the cover depicted in FIG. 5.

FIG. 11 shows the cover depicted in FIG. 5 connected to an optical device.

### DETAILED DESCRIPTION OF EXEMPLARY EMBODIMENTS

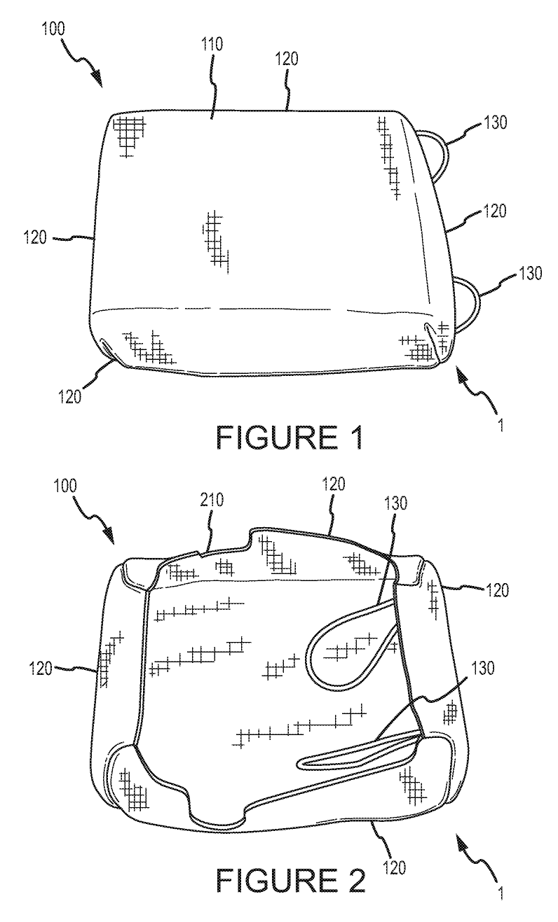

Referring now to the figures, wherein the purpose is to disclose preferred embodiments of the invention and not limit its scope, FIG. 1 shows a cover according to one exemplary embodiment of the present invention. Cover 1 comprises a hood 100 having a closed top portion 110 and four sides 120. Two connectors 130 are attached to cover 100, and in this embodiment are attached to the interior of the flexible hood 100 for attaching cover 1 to an optical instrument or other device (not shown).

Hood 100 is preferably formed from a flexible material to allow it to stretch when being placed on or removed from an optical device, but may be made of a non-flexible material. Hood 100 may include any number of different materials of any type. In the embodiment of the present invention depicted in FIG. 1, for example, hood 100 is formed from a 2 mm-thick, fabric (which may be nylon) covered neoprene. Hood 100 may also include or entirely consist of other types of suitable material, such as cotton, polyester, foam rubber, nylon, neoprene, or any other natural or synthetic material. The material of hood 100 can be of any suitable thickness, and need not be of uniform thickness throughout the entire hood.

The material of hood 100 may be selected to achieve any desired purpose and/or exhibit any desired property. For example hood 100 may be comprised of or include a waterproof material to protect against moisture, and/or include a soft, cushioned material on its interior to protect the optical instrument or device from shock or vibration. Hood 100 may include additional material for padding (such as foam rubber) to protect the optical device. Such padding can be form-fitted to protect a specific device (such as a particular model of binocular), or to allow multiple types of devices to be received in and protected by the hood. The material of hood 100 may be selected to repel dust, reflect heat, and/or protect an optical instrument in any desired manner, and/or selected to allow easy cleaning, such as in a dishwasher, washing machine, by hand, or any other suitable cleaning method.

Hood 100 may additionally include one ore more colors. The color of the hood can be selected for any purpose and according to any criteria. For example the hood color may be selected to match the color of the optical device it covers or to camouflage the optical instrument in a natural surrounding, such as woodlands or desert. Conversely, hood 100 may include one or more color(s) that aid in detection, such as a bright, luminescent, and/or fluorescent color.

Hood 100 is of sufficient size and shape to cover a portion of an optical instrument or device. The hood may cover the entire instrument or device, or just a portion of the device (such as the lenses and/or eyepieces). For example, hood 100 as shown in FIGS. 1-3 is of sufficient size and shape to cover the lenses, eyepieces and top portion of the body of a binocular. Referring to FIG. 2, hood 100 preferably fits snugly around a binocular (not shown), enclosing the binocular within the interior cavity 210 with sides 120 wrapping partially around the underside of the binocular when hood 100 covers the binocular, while the connectors 130 releaseably fasten to each telescope of the binocular.

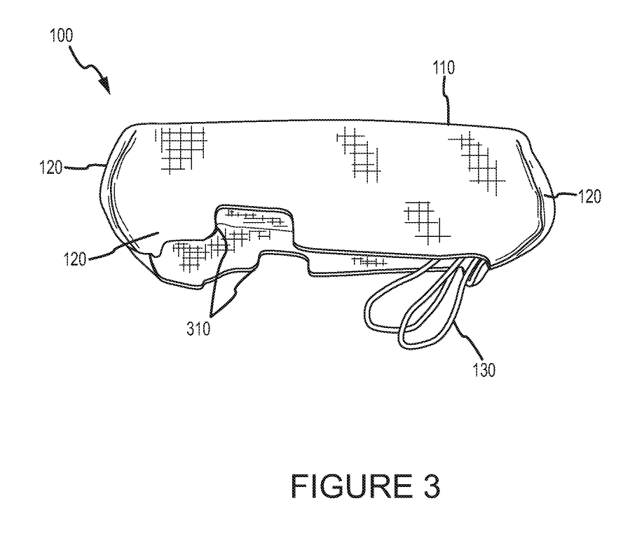

A hood according to the invention may alternatively be configured to cover any portion of a camera, a telescope, or other optical device. The hood can also be configured to cover any portion of other devices (in addition to a binocular), such as the screen and/or keyboard of a personal digital assistant, cellular phone, or other electronic device. The size and shape of the hood can be configured to allow access to one or more portions of a device while allowing other portions to remain covered. As shown in FIG. 3, for example, a preferred embodiment of the hood 100 leaves the underside of binocular body to be extended from the hood 100 while covering other portions of the binocular (such as the lenses and eyepieces). The hood 100 includes voids 310 to allow portions of the binocular (such as a strap for a user's neck) to extend from the hood 100. A hood according to various aspects of the present invention can include any number of such voids in any size, shape, and configuration.

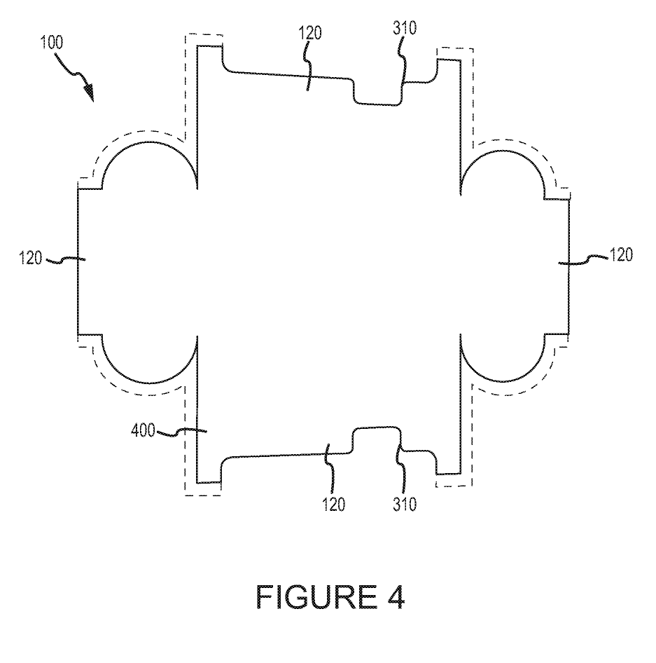

Hood 100 can be manufactured in any manner. Referring to FIG. 4, for example, hood 100 depicted in FIGS. 1-3 may be formed from a single piece of flexible fabric in the shape of pattern 400. The four sides 120 are appropriately sewn together with thread to form hood 100. The pattern 400 may also be assembled into a hood using one or more of glue, tape, loop and hook fasteners, snaps, or any other suitable fastener. The hood may be assembled by hand, automatically by a machine, or a combination of the two, or may be molded as a single piece.

A cover according to various aspects of the present invention can include any other desired features. For example, in one embodiment of the present invention the hood includes at least transparent portion on one or more of the sides to allow an optical instrument to be used while covered by the hood. The transparent portions may be of any size, shape, or composition. For example, a hood for covering a binocular may include four transparent portions, two portions on each opposing side of the hood, wherein the transparent portions align with the eyepieces and the lenses, respectively. The transparent portions can be formed from any suitable material, such as clear plastic or glass. The transparent portions are shaped to correspond to the respective eyepieces or lenses each covers.

The cover may additionally include one or more pockets (not shown) to carry accessories, such as accessories for the covered instrument or device, such as lens cleaning cloths, film, batteries, and/or any other suitable accessory or object. The pocket(s) can be of any size and shape, and may be formed from the same or different material comprising the hood. Each of the pocket(s) may include one or more fasteners for closing the pocket, such a button, snap, hook and loop fastener, and/or zipper. The pocket(s) can be attached externally or internally to the hood. For example, the pocket(s) may be attached to the interior of the hood and be accessed through an opening in the exterior of the hood. The pocket(s) may be of any other suitable configuration.

The cover includes one or more connectors 130 for securing the hood to the optical instrument or device. The connector(s) allows a user to easily cover and uncover the device while securing the hood to the instrument or device when the instrument or device is uncovered. In the exemplary embodiment shown in FIGS. 1-3, two connectors 130 are attached to the interior of the hood 100, although any number of suitable connectors may be used. In this exemplary embodiment, the connectors 130 comprise elastic straps to slide over and grip each of the two telescopes of a binocular.

The connectors 130 may be of any suitable size, shape, and configuration, and may be manufactured of any suitable material to achieve any desired purpose. Connectors 130 may be flexible so they can be stretched to be placed on or taken off the optical instrument or device. They may also be, for example, configured to be tied on, adhesively attached, snapped on, or attached by hook and loop fasteners.

Each connector may be permanently or removably attached to a hood 100. For example, a connector could be removably attached to the hood to allow replacement of the connector and/or to allow cleaning of the hood. The connector may include a strap attached to one half of a snap or hook and loop fastener to connect to an optical instrument or electronic device that includes the other half of the snap or hook and loop fastener.

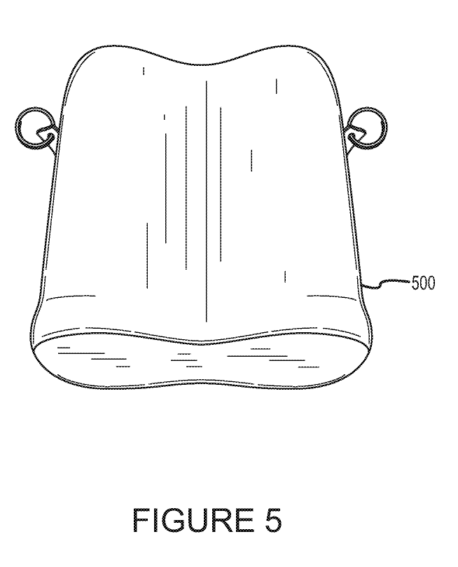

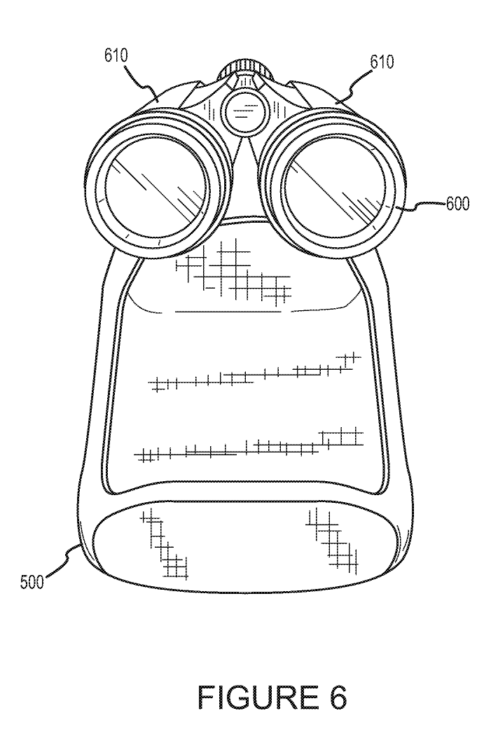

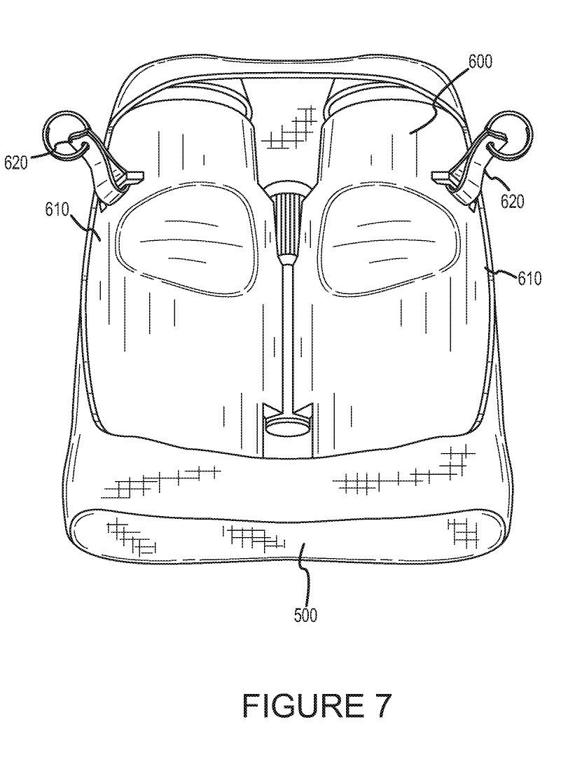

In another exemplary embodiment of the present invention, referring now to FIGS. 5-7, cover 500 is specifically configured to fit a binocular 600. FIG. 5 shows a top view of the cover 500 holding the binocular; FIG. 6 shows the binocular 600 outside the cover 500 and FIG. 7 shows a bottom view of the cover 500 covering the top, lenses, and eyepieces of the binocular 600. As with the embodiment of the present invention depicted in FIGS. 1-4, the cover 500 also includes connectors for fastening to each telescope 610 of the binocular 600 (connectors not shown). As shown in this exemplary embodiment, the portions of the binocular 600 most susceptible to damage (i.e. the lenses and eyepieces) are protected by the cover 500, while leaving the bottom portion of the binocular 600 uncovered to allow a user to quickly and conveniently cover and uncover the binocular. Straps 620 connected to the binocular 600 are able to extend through the exposed bottom of the cover 500. A cover according to aspects of the present invention may be configured to allow any desired portion or feature of a device protected by the cover to extend from the cover.

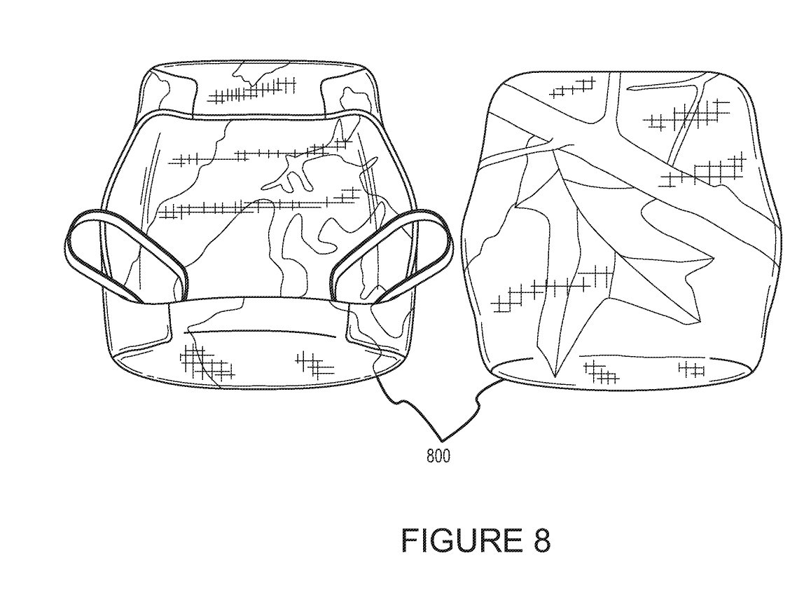

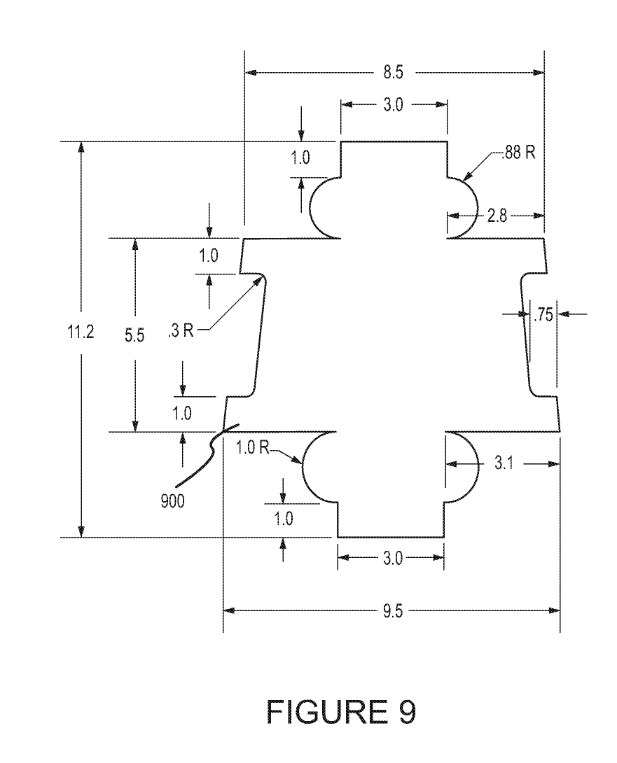

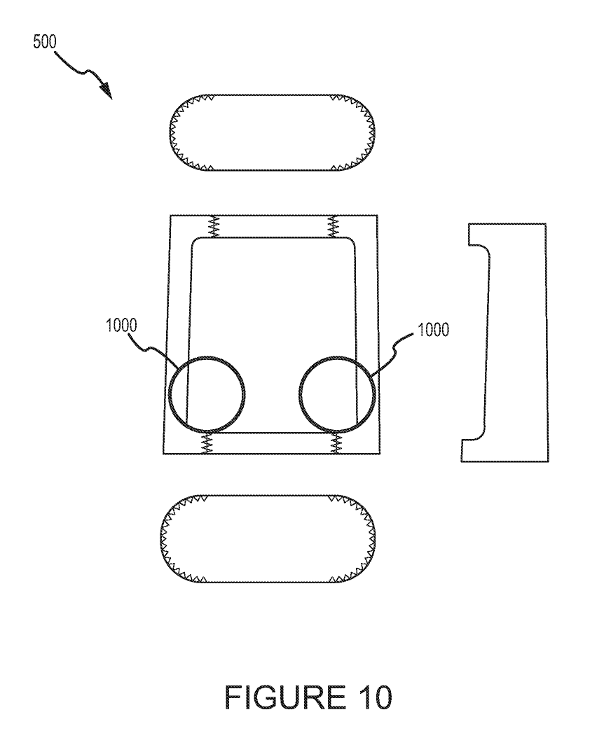

FIG. 8 depicts top and bottom views of an exemplary hood 800 according to the present invention. In this exemplary embodiment, hood 800 is formed from a material designed to camouflage a binocular in a woodland setting. Hood 500 can be manufactured in any manner. Referring to FIGS. 9 and 10, for example, hood 500 may be formed from a single piece of flexible fabric in the shape of pattern 900 having the listed dimensions (in inches). FIG. 10 illustrates how elements of pattern 900 can be sewn together with thread to form hood 500. FIG. 10 also illustrates the attachment of connectors 1000 to connect to a binocular 600. The pattern 900 may also be assembled into a hood using one or more of glue, tape, loop and hook fasteners, snaps, or any other suitable fastener. The hood may be assembled by hand, automatically by a machine, or a combination of the two, or may be molded as a single piece.

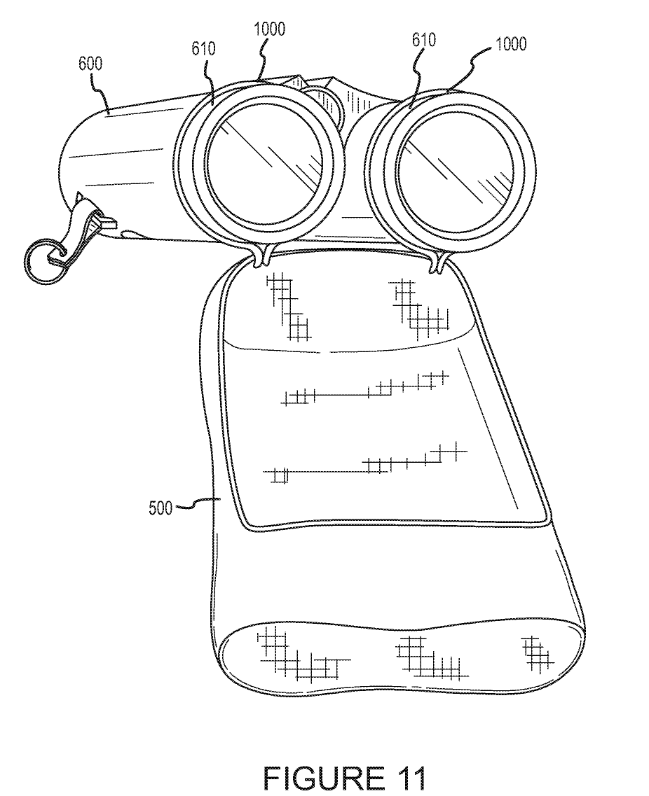

In operation, a user partially covers an instrument or device with the hood to protect the device. The hood remains connected to the device via the one or more connectors when the instrument or device is uncovered. The device can thus be protected while still allowing a user to quickly and easily cover and uncover the device. The connector(s) prevent the cover from being lost and/or separated from the device, and alleviates the need for a user to handle or store the cover. As shown in FIG. 11, for example, the cover 500 includes connectors 1000 for fastening to each telescope 610 of the binocular 600, allowing the cover 500 to hang below the binocular 600 while the binocular 600 is uncovered.

Other embodiments of the invention will be apparent to those skilled in the art from consideration of the specification and embodiments disclosed herein. Thus, the specification and examples are exemplary only, with the true scope and spirit of the invention set forth in the following claims and legal equivalents thereof.

What is claimed is:

1. A cover for a binocular, comprising:
(1) a flexible hood comprising:
(a) a top;
(b) four sides, each of the sides having an exterior surface and an interior surface;
(c) a substantially open bottom; and
(d) a cavity defined by the top and four sidewalls, the cavity for receiving the binocular; and
(2) a first connector for securing the flexible hood to the binocular.

2. The cover of claim 1, wherein the first connector is removably attached to the flexible hood.

3. The cover of claim 1, further comprising a second connector for securing the flexible hood to the binocular.

4. The cover of claim 3, wherein the second connector comprises at least one of an elastic strap, a button, a snap, and a hook and loop fastener.

5. The cover of claim 3, wherein the first connector and the second connector are each attached to a sidewall.

6. The cover of claim 5, wherein the first connector and the second connector are each attached to the interior of a sidewall.

7. The cover of claim 5, wherein the first connector and the second connector are each attached to the same sidewall.

8. The cover of claim 3, wherein the first connector and the second connector are each flexible straps.

9. The cover of claim 8, wherein the binocular comprises a first telescope and a second telescope, wherein the first telescope and second telescope each include an eyepiece and a lens, and wherein the first strap attaches to the first telescope and the second strap attaches to the second telescope.

10. The cover of claim 9, wherein the respective eyepieces for each telescope are at a first end of each telescope and the respective lenses for each telescope are at a second end of each telescope, and wherein the first connector attaches to the second end of one of the telescopes and the second connector attaches to the second end of the other telescope.

11. The cover of claim 9, wherein a portion of the binocular that is alternately covered and uncovered includes the eyepiece.

12. The cover of claim 9, wherein a portion of the binocular that is alternately covered and uncovered includes the lens.

13. The cover of claim 9, wherein a portion of the binocular that is alternately covered and uncovered includes the eyepiece and the lens.

14. The cover of claim 9, wherein the first connector comprises flexible straps releasably connected to the first telescope and the second telescope.

15. The cover of claim 9, wherein the eyepiece can be covered and alternately uncovered without uncovering the lens.

16. The cover of claim 1, wherein the flexible hood includes at least one transparent portion to allow the use of the binocular while the hood is partially covering the binocular.

17. The cover of claim 16, wherein the at least one transparent portion is formed from clear plastic.

18. The cover of claim 1, wherein the hood is waterproof.

19. The cover of claim 1, wherein the hood is configured to repel dust.

20. The cover of claim 1, wherein the hood is comprises a flexible material.

21. The cover of claim 1, further comprising a pocket attached to the flexible hood.

22. The cover of claim 21, wherein the pocket includes a fastener for closing the pocket.

23. The cover of claim 22, wherein the fastener includes at least one of a button, a snap, a hook and loop fastener, and a zipper.

24. The cover of claim 1, wherein the flexible hood is formed from a single piece of material.

25. The cover of claim 1, wherein the flexible hood is formed from at least one of cotton, foam rubber, nylon, elastane, neoprene and polyester.

26. The cover of claim 1, wherein sides are configured to partially extend around the binocular.

27. The cover of claim 1, wherein hood includes one or more voids to allow one or more portions of the binocular to extend therethrough.

28. A cover for an optical instrument, comprising:
a hood for partially covering the optical instrument, and alternately uncovering the optical instrument; and
a first connector attached to the flexible hood, the first connector for securing the flexible hood to the optical instrument while the optical instrument is uncovered by the flexible hood.

29. The cover of claim 28, wherein the first connector comprises one or more elastic straps.

30. The cover of claim 28, wherein the first connector is removably attached to the flexible hood.

31. The cover of claim 28, further comprising a second connector attached to the flexible hood, wherein the second connector is also for securing the flexible hood to the optical instrument while the optical instrument is uncovered by the flexible hood.

32. The cover of claim 31, wherein the second connector comprises at least one of an elastic strap, a button, a snap, and a hook and loop fastener.

33. The cover of claim 28, wherein the optical instrument includes at least one eyepiece and at least one lens.

34. The cover of claim 33, wherein the eyepiece is at a first end of the optical instrument and the lens is at a second end of the optical instrument, and wherein the first connector attaches to the second end of the optical instrument.

35. The cover of claim 34, wherein the first connector is one or more straps.

36. The cover of claim 34, wherein the optical instrument is a binocular.

37. The cover of claim 36, wherein the first connector is two straps.

38. The cover of claim 33, wherein a portion of the optical instrument that is alternately covered and uncovered includes the eyepiece.

39. The cover of claim 36, wherein a portion of the optical instrument that is alternately covered and uncovered includes the lens.

40. The cover of claim 36, wherein a portion of the optical instrument that is alternately covered and uncovered includes the eyepiece and the lens.

41. The cover of claim 36, wherein the first connector comprises flexible straps releasably connected to the second end and the portion of the optical instrument includes at least one of a lens and an eyepiece.

42. The cover of claim 33, wherein the eyepiece can be covered and alternately uncovered without uncovering the lens.

43. The cover of claim 28, wherein the flexible hood includes at least one transparent portion to allow the use of the optical instrument while the hood is partially covering the optical instrument.

44. The cover of claim 43, wherein the at least one transparent portion is formed from clear plastic.

45. The cover of claim 28, wherein the hood is waterproof.

46. The cover of claim 28, wherein the hood is configured to repel dust.

47. The cover of claim 28, wherein the hood is comprises a flexible material.

48. The cover of claim 48, wherein the hood is formed from at least one of cotton, foam rubber, nylon, elastane, neoprene and polyester.

49. The cover of claim 28, further comprising a pocket attached to the flexible hood.

50. The cover of claim 49, wherein the pocket includes a fastener for closing the pocket.

51. The cover of claim 49, wherein the fastener includes at least one of a button, a snap, a hook and loop fastener, and a zipper.

52. The cover of claim 28, wherein hood includes one or more voids to allow one or more portions of the optical instrument to extend therethrough.
